(19) United States
(12) Patent Application Publication
(10) Pub. No.: US 2009/0308379 A1
(43) Pub. Date: Dec. 17, 2009

(54) HYPERBOLIC SOLAR TROUGH FIELD SYSTEM

(76) Inventor: Rahmi Oguz Capan, Marmaris (TR)

Correspondence Address: INDIANAPOLIS OFFICE 27879;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/299,213

(22) PCT Filed: May 5, 2006
(86) PCT No.: PCT/IB06/51421

§ 371 Date: Feb. 12, 2009

(51) Int. Cl. F24J 2/10

(52) U.S. Cl. 126/692

(57) ABSTRACT

The subject matter of the invention of hyperbolic solar trough field system (B, II) comprises hyperbolic reflectors (20, 20m) in which the beams that come from the sun parallel, but of which the angle of incident changes at a fixed rate of 15 degrees per hour throughout the day are concentrated on the focal axis in the bottom part thereof, thermal receiver tubes (21) which extend throughout said focal axis and are at a fixed position, and side supports (23, 23′) which are at a ground-fixed position on the both sides of the reflectors. The reflectors (20, 20m) are connected to the ground from at least one rotary joint (22) point such that said reflectors can rotate around the central axis of the thermal receiver tubes (21). The bottom part of hyperbolic reflectors (20, 20m) has been produced as circular sectioned such that it surrounds the thermal receiver tubes (21) somewhat, on the continuation; a hyperbola form has been given to its arms extending towards two sides. Other hyperbolic reflectors (20m) are also provided with a bigger second hyperbola form which starts from the point where said hyperbola form finishes.

### TECHNICAL FIELD

This invention relates to the hyperbolic trough-shaped collectors which concentrate the sunlight on a focus and convert it into another energy forms such as heat and electricity.

### PRIOR ART

Currently, trough collectors (solar trough field system) are used to collect the sun's energy in order to obtain electricity and heat therefrom. These systems comprise trough-shaped long parabolic reflectors, thermal receiver tubes which are placed on the focus of the reflectors, and where beams coming from the reflector are collected and in which a fluid exists, and a rotating mechanism which directs the reflectors to the position where the sun is. The beams coming to the reflectors which are directed towards the sun reflect and are collected on the thermal receiver tube which is located on the focus of the reflector. Thermal receiver tube is provided with two nested tubes where a vacuum setting is located in the space therebetween. A fluid, which provides the heat transfer, is passed through the inner tube. The outer tube is made of glass. By concentrating the beams coming from the reflectors on the thermal receiver tube, this tube reaches very high temperatures; therefore, the fluid located in the inner tube can be heated. Heat energy can be converted into the electric energy, when desired, with this fluid which reaches high temperatures. However, the factors such as thermal receiver tubes used in these systems being many meters long, said thermal receiver tubes following the sun together with the reflectors, outer parts thereof being made of glass increase their possibility of breaking during operation. In addition, dynamic and static forces which are generated by the wind can cause both reflectors and tubes to break. In order to decrease the breaking of the parabolic reflectors, a truss structure is formed to support the reflectors on their convex sides. However, this structure decreases only the rate of breaking and is not a complete solution for breaking. The vibrations generated as a result of the movement which is made by the system for directing towards the sun can also cause the glass tubes to break. The solar trough field systems which are built on California (USA) by LUZ can be given as an example for these systems. In that system of LUZ, the parabolic reflectors which are many meters long and the thermal receiver tubes which are located on their focus are rotated together. The most fundamental problem of this system is that the thermal receiver tubes which are made of a fragile material are movable. As long as the thermal receiver tubes are movable, they are subjected to more torque load and the flexible hoses are used in the connections of the beginning and ending points of the parabolic reflectors with the fixed tubes. The thermal receiver tubes which are subjected to the torque loads have a higher possibility of breaking. On the other hand, it is clear that the flexible hose connection is not a safe system since the temperature of the fluid which is transferred within the thermal receiver tube is 300-500° C. In addition, it has been obtained from the field observations that the truss structure, which supports the parabolic mirrors, is also weak against the torque and the moment loads acting due to the drive unit of the system and the wind. Because of these loads, the parabolic reflectors are frequently broken, thus causing the operating costs to increase.

Due to the problems encountered in the above-mentioned system of LUZ, a so-called EUROTROUGH project which is supported by the European Union is initiated. In the scope of this project, the lower part of the parabolic reflectors is supported by a truss structure which can resist more against the torque and the moment loads, and there are inflexible movable tubes attached to the rotary joint on the connection points of the movable thermal receiver tubes with the fixed tubes. Although the truss system which is developed with EUROTROUGH is safer than the system of LUZ, it could not strictly eliminate the breaking problem of the parabolic reflectors and the thermal receiver tubes. It has been understood from the field observations that the possibility of breaking the thermal receiver tubes decreases only to some extent since they are movable in this system as well. In addition, it has been also revealed from the field observations that the hot fluid frequently leaks out from these connections of the thermal receiver tubes comprising rotary joint connection points.

Another problem observed with LUZ and EUROTROUGH is that the hydraulic pistons of both systems cannot move with the required accuracy to follow the sun. It is highly difficult and generates an adjustment problem to make an accurate speed control with the hydraulic piston units and provide simultaneous operations of multiple piston units which are used for multiple parabolic reflectors. Additionally, in both systems, while following the sun, continuous displacement of the center of gravity causes more energy consumption to run these systems.

With the invention, the solar trough field systems with hyperbolic reflector are explained as an alternative to the solar trough field systems with parabolic reflector. In the inventive solar trough field systems with hyperbolic reflector, the sun's energy is used through keeping the reflectors fixed at three different positions in the east, azimuth axis and west directions.

In this invention, the solar troughs with hyperbolic reflector rotating around a fixed thermal receiver tube are used. The hyperbolic reflectors focus the beams coming from a range of 60 degrees from the sun on a thermal receiver tube placed into the focus of a hyperbola, which is located at the bottom point thereof. Therefore, the necessity to direct all hyperbolic reflectors, which are many meters long, with the same accuracy towards the sun is eliminated. Besides, using multiple motor units with lesser capacity instead of a single motor unit which has sufficient capacity to rotate all reflectors in the system, entire system stoppage is prevented even if some of the motors fail. In addition, in order to decrease the maintenance and replacement expenses which will occur in case of breaking the hyperbolic reflectors and more importantly, decrease the manufacturing cost significantly, it is considered to use multi-piece hyperbolic reflectors instead of single-piece parabolic reflectors. Owing to the multi-piece hyperbolic structure, even if some reflector parts are broken, the system can continue to run without suffering too much efficiency loss.

In addition to these, with some changes made on the thermal receiver tube in the collector system as an alternative, the efficiency is ensured to increase. The developments made in this point are related to the use of heat transfer fins within the thermal receiver tubes. On the other hand, an advantage obtained from keeping the thermal receiver tubes fixed is the direct steam generation. Some difficulties are encountered during the direct steam generation in the thermal receiver tubes with flexible hose connection or rotary joint connection which are used in the prior art, and the generated steam leaks out to external environment from said connection points.

### AIM OF THE INVENTION

An aim of the invention is to form a hyperbolic solar trough field system in which the beams coming from the sun parallel and at angles which change at a fixed rate of 15 degrees per hour throughout the day are concentrated on the focal axis in the bottom part of the hyperbolic reflector that can rotate around this focal axis, and also comprising the thermal receiver tubes which are at a fixed position, extend throughout said focal axis.

Another aim of the invention is to build a hyperbolic solar trough system which is directed towards the sun only by waiting at three positions using the hyperbolic reflectors instead of forming a reflector which is continuously moving. Thus, it is to ensure that the necessity for the movement of the reflector to be fast and accurate at that time is eliminated owing to the beam collection feature of the reflector from a range of 60 degrees.

Also, another aim of the invention is to decrease the maintenance and replacement expenses which will arise in case of breaking the reflectors used as single-piece and to ensure the use of multi-piece hyperbolic reflectors instead of single-piece ones in order to prevent the system from suffering too much efficiency loss even if some reflector parts are broken.

Another aim of the invention is to provide an efficiency increase by using heat fins in the thermal receiver tubes.

Also, another aim of the invention is to ensure that the reflectors are positioned using motors with lesser capacity instead of a single motor unit which has sufficient capacity to rotate all reflectors, and the entire reflector system continues to run even if some of the motors fail.

### DESCRIPTION OF THE DRAWINGS

The hyperbolic solar trough field system is shown in the attached drawings, wherein:

FIG. 1 is a side view of the subject matter of invention solar trough field system with hyperbolic reflector.

FIG. 2 is a side view of the hyperbolic reflector's position facing towards the east direction.

FIG. 3 is a side view of the hyperbolic reflector's position which is parallel to the azimuth axis.

FIG. 4 is a side view of the hyperbolic reflector's position facing towards the west direction.

FIG. 5 is a multi-piece side view of the hyperbolic reflector in the solar trough field system with hyperbolic reflector.

FIG. 6 is a side view of the solar trough field system with hyperbolic reflector along with the drive and support units.

FIG. 7 is a front view of the solar trough field system with dual-stage hyperbolic reflector along with the lock mechanisms.

FIG. 8 is a side view of the solar trough field system with dual-stage hyperbolic reflector.

FIG. 9 is a side view of the dual-stage hyperbolic reflector's position facing towards the east direction.

FIG. 10 is a side view of the dual-stage hyperbolic reflector's position which is parallel to the azimuth axis.

FIG. 11 is a side view of the dual-stage hyperbolic reflector's position facing towards the west direction.

FIG. 12 is a multi-piece side view of the hyperbolic reflector in the solar trough field system with dual-stage hyperbolic reflector.

FIG. 13 is a side view of the solar trough field system with dual-stage hyperbolic reflector along with the drive and support units.

FIG. 14 is a front view of the solar trough field system with dual-stage hyperbolic reflector along with the lock mechanisms.

The parts in the figures are numbered one by one and the corresponding terms of these numbers are given below.

Hyperbolic solar trough field system (B)

Hyperbolic solar trough field system (H)

Hyperbolic reflector (20)

Hyperbolic reflector (20m)

Hyperbola form (20m′, 20m″)

Thermal receiver tube (21)

Rotary joint (22)

Side supports (23, 23′)

Pistons (24, 24′)

Azimuth locks (25a, 25a′)

East lock (25d)

West lock (25b)

Guy wires (26, 26′)

Pulleys (27, 27′)

Reflector connections (28)

Support ring (29)

Lightweight Filling Material (30)

### DISCLOSURE OF INVENTION

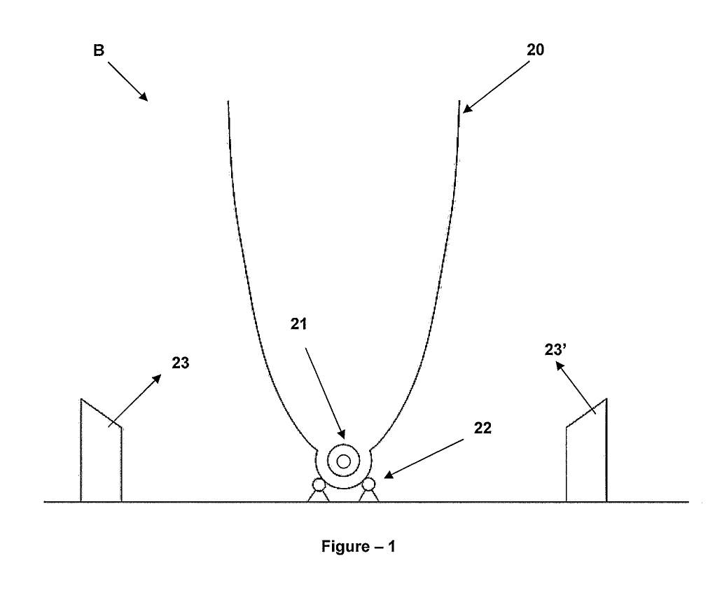

FIG. 1 provides a side view of, the subject matter of invention, hyperbolic solar trough field system (B). Said hyperbolic solar trough field system (B) comprises hyperbolic reflectors (20) in which the beams that come from the sun parallel and the angle of incident thereof changes at a fixed rate of 15 degrees per hour throughout the day are concentrated on the focal axis in the bottom part thereof, thermal receiver tubes (21) which extend throughout said focal axis and are at a fixed position, and side supports (23, 23′) which are at a ground-fixed position on the both sides of the reflector (20). The reflectors (20) are connected to the ground from at least one rotary joint (22) point such that said reflectors (20) can rotate around the central axis of the thermal receiver tubes (21). The bottom part of said hyperbolic reflector (20) has been formed as circular sectioned such that it surrounds the thermal receiver tubes (21) somewhat, on the continuation; a hyperbola form has been given to its arms extending towards two sides. In this way, the beams coming from the sun parallel and at varying degrees reflect from the inner surface of the hyperbolic reflector (20) and concentrate on the thermal receiver tubes (21), and the concentration of the light coming onto the tube (21) is increased, thus ensuring the more efficient operation of the hyperbolic solar trough field system (B).

The hyperbolic reflector (20) which is contained in said system (B) has a structure which is able to focus the beams coming from a range of approximately 60 degrees from the sun onto the thermal receiver tubes which are located at the bottom part thereof. By means of said system (B), non-imaging type light concentration is generated on the thermal receiver tubes.

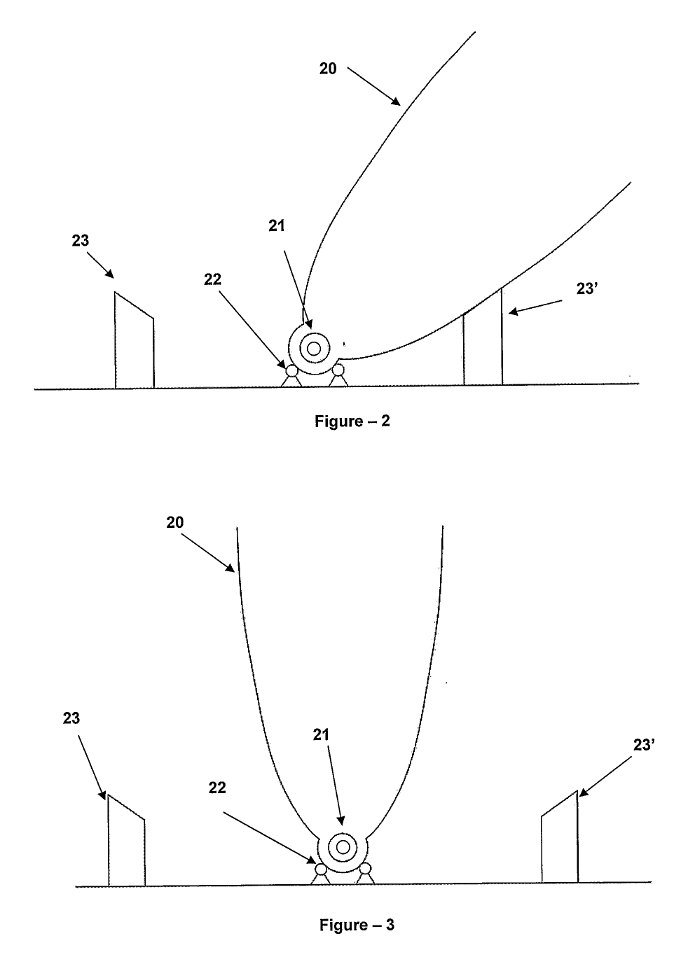

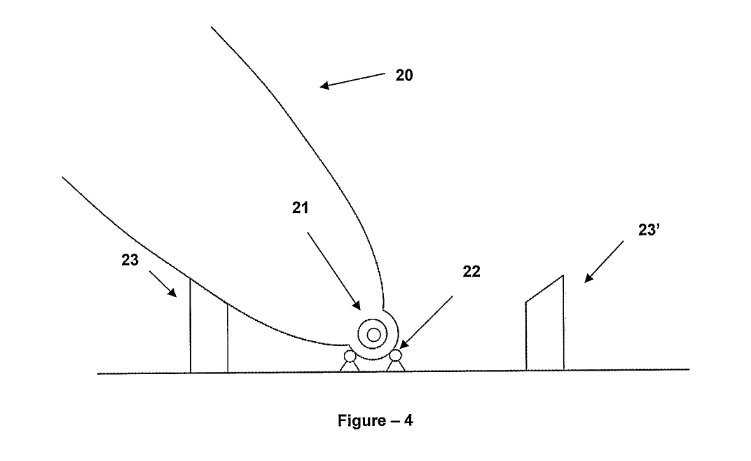

Since said hyperbolic reflector (20) is connected to the ground from its bottom part with the rotary joints (22), the reflector (20) can be directed towards the sun by rotating with the use of any drive mechanism which is associated with these joints (22) and/or reflectors (20). Considering that there is a route of movement of approximately 180 degrees between sunrise and sunset, the hyperbolic reflector (20) remains at a fixed position, as in the demonstration in FIG. 2, on the side support (23′) in the east direction during the time to reach the zenith angle of approximately 60 degrees after sunrise. While the sun continues its travel towards the apex point of the elliptic route that it follows after completing the zenith angle of approximately 60 degrees, the hyperbolic reflector (20) is rotated and brought into a position where it is parallel to the azimuth axis—the axis which combines the earth plane and the apex point also known as zenith point and is perpendicular to the earth plane. Due to the beam collection feature of said reflector (20) from a range of 60 degrees, the movement of the reflector does not have to be fast and accurate at that time; there is a sufficiently long time interval to reach the parallel position with the azimuth axis. This position is shown in FIG. 3. To keep the hyperbolic reflector (20) in this position, different lock mechanisms (FIG. 7) can be used. After the sun's zenith angle sweeping of approximately 120 degrees, the hyperbolic reflector (20) is rotated to the west direction again and is changed this time to a fixed position on the side support (23) in the west direction. After the sun completes the zenith angle of approximately 120 degrees, the hyperbolic reflector (20) is kept in the west direction as also shown in FIG. 4 during the time to sunset point. Following the sunset, the hyperbolic reflector (20) are brought back to its initial position through re-rotating towards the east direction—there is a long time like all night for this operation—and positioning on the side support (23′) in the east direction. In cases where the geographical regions in which the said system (B) is used are different, e.g. in cases where these systems (B) are located below or above the sea level, or surrounded by heights; the movement angle of the sun on the earth all day may be relatively different. In other words, the sun can sweep a more or less angle than the movement route of 180 degrees as mentioned above. In these cases, the heights of the side supports (23, 23′) might also be different according to the characteristics of the geographies in which the said systems (B) are used. In such cases, the apertures of the hyperbolic reflectors (20) and the heights of the side supports (23, 23′) can be adjusted such that they divide the route that sun follows into three equal parts. For example, considering the movement route of 180 degrees and that the sun rises from a level of 0 degree and declines from a level of 180 degrees as mentioned above, the aperture of the reflectors (20) can be adjusted such that it will collect the beams coming from a range of 60 degrees and the heights of the side supports (23, 23′) can be adjusted such that they will direct the reflectors (20) to an axis of 30 degrees from the horizon when the reflectors (20) are seated thereon.

Since the reflectors (20) in the hyperbolic solar trough field system (B) collect the sunlight from a range of approximately 60 degrees and thus are located only in three positions in a day, the necessity for reflectors (20) to move synchronously with each other during position change is eliminated. Thus, accurate and continuous sun tracking is not needed, and there is no need for the complex electronic control units and programs which are necessary for this tracking. This critical consideration decreases not only the design, manufacturing and maintenance expenses substantially but also simplifies the operation equally.

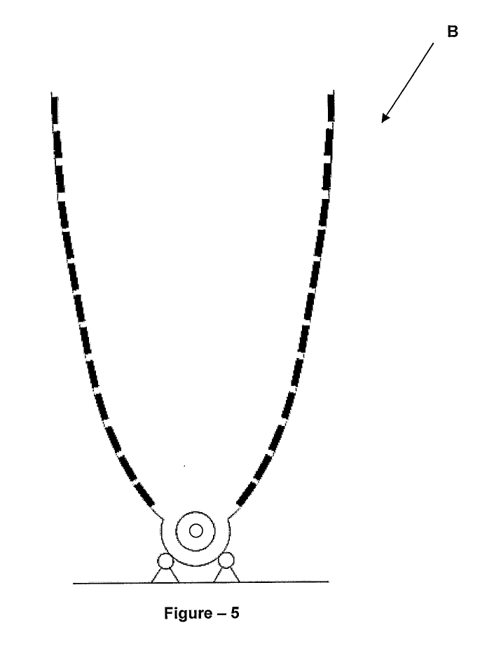

Besides the sun tracking activity with continuous and accurate movement through the said system (B) decreases the production, maintenance and repair costs of the system (B), the multi-piece reflectors may also be used in order to decrease the costs arising from the single-piece hyperbolic reflector manufacturing. FIG. 5 provides a multi-piece side view of the hyperbolic reflector in the hyperbolic solar trough field system (B). By means of the invention, instead of single-piece ones, longitudinal multi-piece hyperbolic reflectors can also be used alternatively. By means of this multi-piece structure, even if some reflector parts are broken, it is easy to change them. In addition, the breaking of single-piece reflectors due to the external effects can damage the substantial part of the reflectors. By means of multi-piece structure, only the reflectors which remain under the effect are broken, and the possibility of damage to entire hyperbola decreases. In addition, maintenance and replacement expenses, which may arise when the hyperbolic reflectors are broken, decrease and even if some reflector parts are broken, the system can continue to run without suffering too much efficiency loss. In the multi-piece hyperbolic reflectors, the edge width of those which are close to the center of the hyperbola is narrow and the width of these reflector parts increases towards the sides of the hyperbola. The surfaces of the multi-piece hyperbolic reflectors which face towards the thermal receiver tubes can be produced in two different ways. The first alternative is to make these surfaces planar. The reflectors which are placed on the concave surfaces of this hyperbolic solar trough are placed on this trough such that they reflect the light coming onto their flat surfaces to the thermal receiver tube. The second alternative is that said surfaces of these multi-piece reflectors are each in the form of a hyperbola section. In other words, said multi-piece reflector is made of bringing the longitudinal sections of a single hyperbolic reflector together. When said hyperbola sectioned reflectors are positioned longitudinally and collaterally on the concave surface of a hyperbolic solar trough again, a multi-piece hyperbolic reflector system, where the focal point of each is the thermal receiver tube, is produced. In the said system (B), if the flat-surface reflector parts which are proposed as the first alternative are used, each flat panel should be narrow in width and therefore the number of panels used should be too many in order to allow a better focusing. If the multi-piece reflectors made of hyperbolic sections which are proposed in the second alternative are used, it is possible to use less reflector parts since each reflector width is wider than the flat-surface ones. Since both alternatives have their own advantages, a selection can be made between these two alternatives according to the manufacturing capacity. Owing to their flat surfaces, manufacturing of the reflector parts mentioned in the first alternative is easier than the manufacturing of the hyperbolic sectioned reflector parts. Besides, although the manufacturing of the hyperbolic sectioned reflectors are more difficult, they focus the sunlight better.

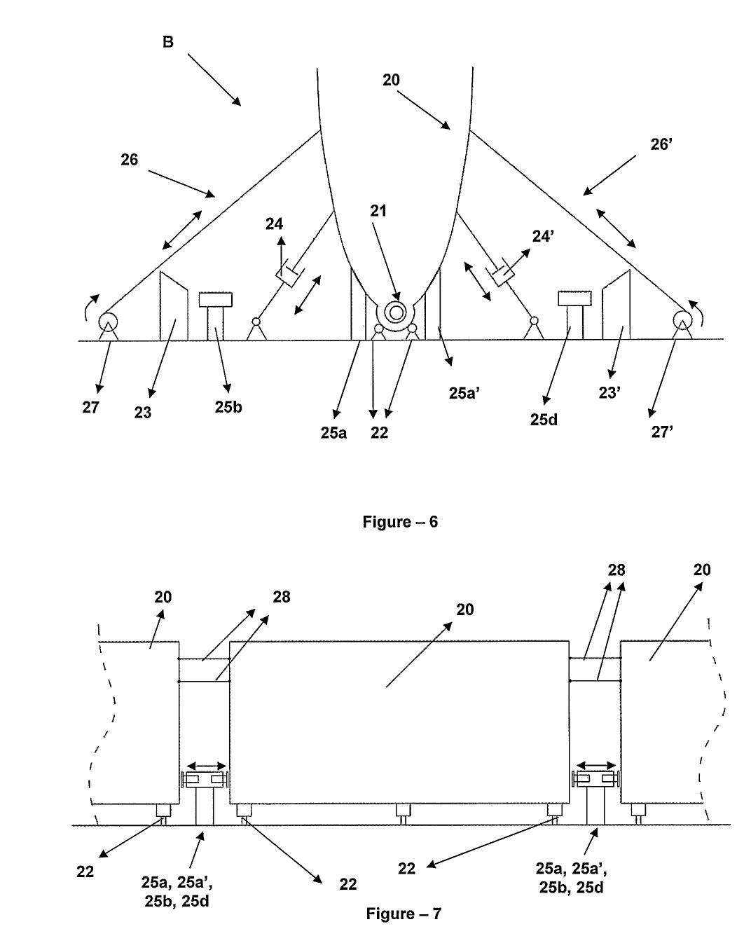

FIG. 6 provides a side view of the said hyperbolic solar trough field system (B) along with the drive and support units. In order to rotate the hyperbolic reflectors (20) around a pivot point, different drive mechanisms can be used. These mechanisms can be in the form of motor-reducer units or chain-gear or belt-pulley arrangements which are attached to these units and additionally in the form of drive arms. These said mechanisms (not shown in the figures) can be attached to the rotary joints (22) or the hyperbolic reflector (20). By means of these mechanisms, the hyperbolic reflectors (20) can be rotated around the focal axis. By the invention, it is preferred to position the reflectors using multiple motors with less capacity. In this way, by using multiple motors instead of a single motor unit which has sufficient capacity to rotate all reflectors, it is aimed that the entire reflector system continues to run even if some of the motors fail.

Another example of the drive mechanisms may be hydraulic or pneumatic pistons (24, 24′) as shown in FIG. 6. It is possible to position the reflectors (20) in the east-west direction with the help of the pistons (24, 24′) of which one ends are connected to the sides of the hyperbolic reflectors (20) and other ends are connected to a fixed point. Or the reflectors (20) can be positioned with the help of the guy wires (26, 26′) of which one ends are connected to the side of the reflectors (20) and other ends are each connected to one pulley (27, 27′). During the use of guy wires (26, 26′) as the drive system, the length of these wires (26, 26′) can be adjusted according to the rotation of the pulleys rotated by individual drive units.

In the said hyperbolic solar trough field system (B), the lock mechanisms (25a, 25a′, 25b, 25d) can also be used in order to protect the hyperbolic reflectors (20) from the wind loads and reduce the oscillation amount when they are at a fixed position. Owing to these mechanisms which are positioned on the beginning and ending parts of the hyperbolic reflectors (20), when the reflectors are changed to the fixed position in the east, azimuth axis and west directions, the arms of the lock mechanisms move in the north-south direction and support the reflector (20) in its fixed positions. When the reflectors (20) are changed to the east position, they are kept fixed between the side supports (23′) and the east locks (25d). When the reflectors (20) are changed to the parallel position to the azimuth axis, they are kept fixed between the azimuth locks (25a, 25a′). When the reflectors (20) are changed to the west position, they are kept fixed between the side supports (23) and the west locks (25b). FIG. 7 provides a front view of the hyperbolic reflectors (20) along with the lock mechanisms (25a, 25a′, 25b, 25d). When the reflectors (20) are desired to be kept in a fixed position, the movable arms in the lock mechanisms move in the north-south direction and lock the reflectors (20); when the reflectors (20) are required to change the position, they move again in the north-south direction and release the reflectors. In case where the multiple hyperbolic reflectors (20) are used, the reflector connections (28) shown in FIG. 7 are used as a connection member between the reflectors (20) in order to connect each reflector (20) to each other and thus allow them to move together. The positions of the reflector connections (28) are at the top parts of the reflectors (20) such that they do not strike the lock mechanisms (25a, 25a′, 25b, 25d).

Different alternatives can be applied for the thermal receiver tubes (21) which are used in the hyperbolic solar trough field system (B). In the first alternative, the thermal receiver tube (21) consists of two tubes which are nested, concentric with each other and have a vacuum space therebetween. A fluid is passed through the inner tube, which is called transfer tube, with high thermal conductivity for the heat transfer. Outer glass tube allows the beams coming from the hyperbolic reflectors to reach directly the transfer tube. The temperature of the transfer tube and the fluid therein increases in this way. In order to avoid heat loss through convection from transfer tube to outside, a vacuum space is created between the glass tube and the transfer tube.

In the second alternative, unlike the previous thermal receiver tube, this tube is made of glass and the heat fins with high thermal conductivity are used therein in order to heat the fluid passing through this tube more quickly. As well as, said heat fins may be the fins which are in the form of a plate; they may be used in the form of pins as well. Plate-shaped fins provide manufacturing and mounting easiness compared to pin-shaped fins. Since the pin-shaped ones cast a less shadow on one another, they are more efficient than the plate-shaped ones. It is possible to use both fin structures in this system (B). In the second alternative, it is required to use a second glass tube on the outer parts of the suitable thermal receiver tubes such that a vacuum space will be between said glass tube and the inner tube. The heat fins which are suitable for the second alternative are located longitudinally inside the glass tube and integrally with this tube.

Since the thermal receiver tube (21) is somewhat surrounded by the hyperbolic reflector (20) in the hyperbolic solar trough field system (B), it is less affected by the external environment conditions. Therefore, since the outer glass tube is not preferred in the thermal receiver tube (21) which is suitable for the above-mentioned first alternative, there is no need to perform the operations such as combining the glass tubes which are many meters long, creating a vacuum space, providing tightness; and there arises an opportunity to save money on the issues such as material, workmanship, maintenance, repair owing to the absence of these glass tubes which are the most fragile components of the system even if they are in a fixed position.

The above preferred hyperbolic solar trough field systems (B) are not intended to limit the protection scope of the invention. According to the information described with the invention, the modifications to be performed on this preferred hyperbolic solar trough field systems (B) should be evaluated within the protection scope of the invention.

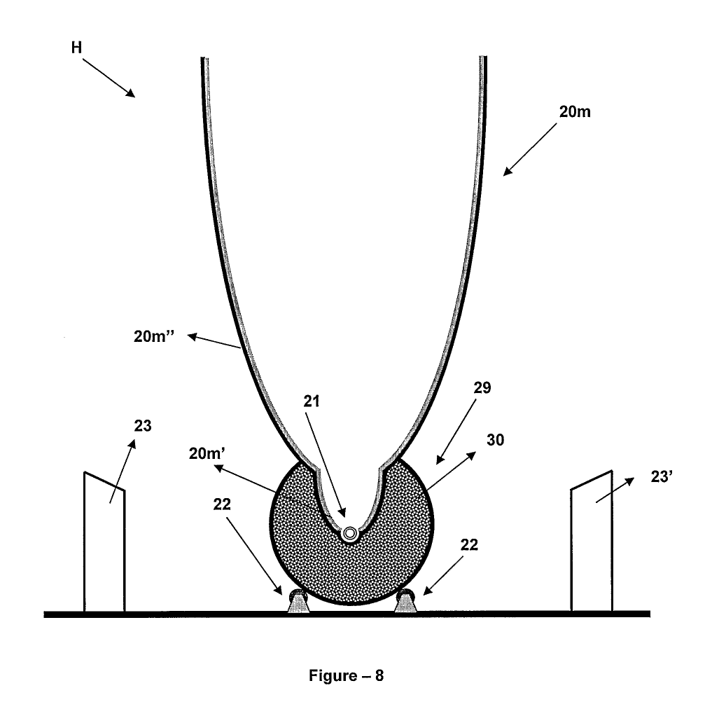

FIGS. 7-14 show an alternative hyperbolic solar trough field system (H). The hyperbolic solar trough field system (H) of which side view is provided in FIG. 7 comprises hyperbolic reflectors (20m) in which the beams that come from the sun parallel and the angle of incident thereof changes at a fixed rate of 15 degrees per hour throughout the day are concentrated on the focal axis in the bottom part thereof, thermal receiver tubes (21) which extend throughout said focal axis and are at a fixed position, and side supports (23, 23′) which are at a ground-fixed position on the both sides of the reflector. The reflectors (20m) are connected to the ground from at least one rotary joint (22) point such that said reflectors can rotate around the central axis of the thermal receiver tubes (21). The bottom part of said hyperbolic reflector (20m) has been produced as circular sectioned such that it surrounds the thermal receiver tubes (21) somewhat, on the continuation; a hyperbola form (20m′) has been given to its arms extending towards two sides. A bigger hyperbolic structure (20m″) which starts from the point where said hyperbola form (20m′) finishes and extends towards both sides is generated again in the form of a hyperbola. The hyperbolic reflector (20m) comprising dual-stage hyperbolas (20m′, 20m″) is formed such that firstly the beams coming from the sun parallel and at varying degrees reflect from the inner surface of the big hyperbolic form (20m″) and reach the inner surface of the small hyperbola form by passing through the aperture of the small hyperbolic form (20m′) and then are concentrated on the thermal receiver tubes (21) by reflecting therefrom. The intended use of the dual-stage hyperbolas (20m′, 20m″) is to ensure the more efficient operation of the hyperbolic solar trough field system (H) by concentrating the beams coming from the sun more on the tube (21). Thus, the problem concerning the concentration of the sunlight on the thermal receiver tubes is reduced with the enlarged hyperbolic reflectors (20m). The aperture of the small hyperbola form (20m′) mentioned herein is equal to the focus area of the big hyperbola form (20m″). Therefore, this small hyperbola form (20m′) re-concentrates the light focused by the big hyperbola form (20m″) so as to be collected in its bottom.

The hyperbolic reflector (20m) which is contained in said system (H) has a structure which is able to focus the beams coming from a range of approximately 60 degrees from the sun onto the thermal receiver tubes which are located at the bottom part thereof. With the said system (H), non-imaging type light concentration is generated on the thermal receiver tubes.

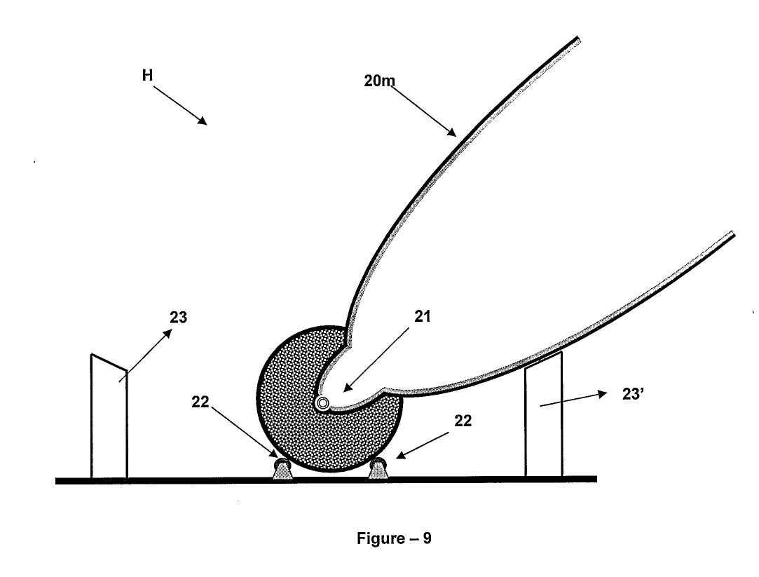

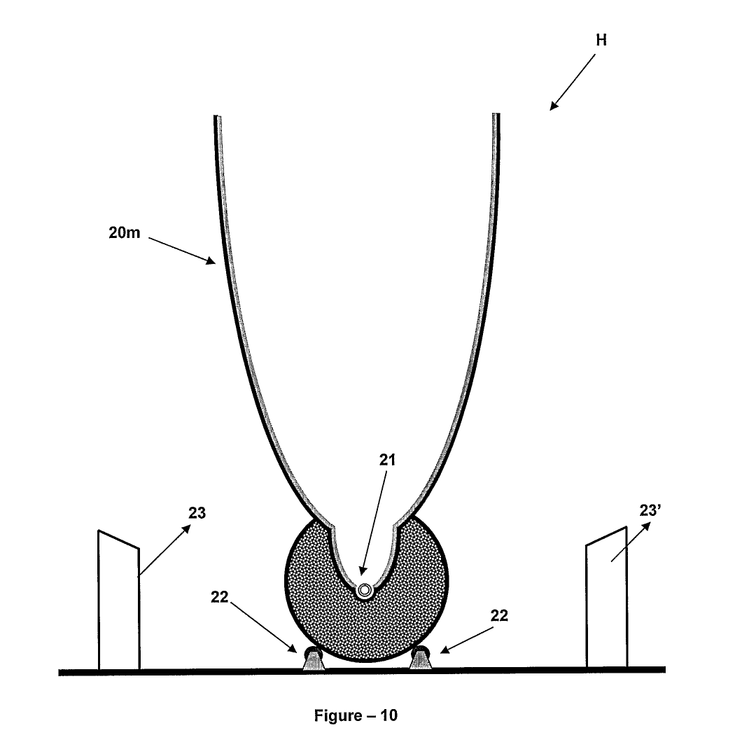

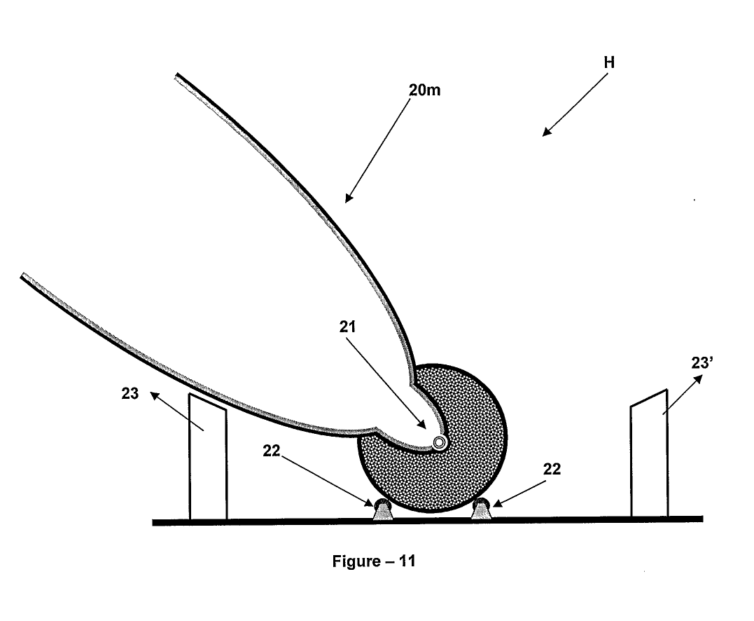

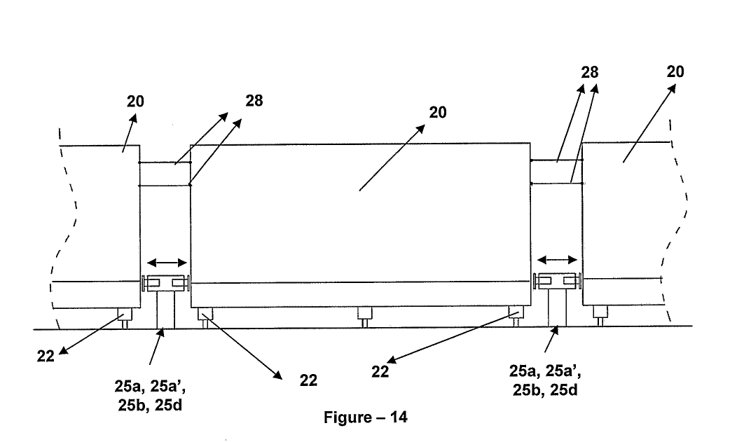

Since said hyperbolic reflector (20m) is connected to the ground from its bottom part with the rotary joints (22), the reflector (20m) can be directed towards the sun by rotating with the use of any drive mechanism which is associated with these joints (22) and/or reflectors (20m). Considering that there is a route of movement of approximately 180 degrees between sunrise and sunset, the hyperbolic reflector (20m) remains at a fixed position, as in the demonstration in FIG. 9, on the side support (23′) in the east direction during the time to reach the zenith angle of approximately 60 degrees after sunrise. While the sun continues its travel towards the apex point of the elliptic route that it follows after completing the zenith angle of approximately 60 degrees, the hyperbolic reflector (20m) is rotated and brought into a position where it is parallel to the azimuth axis. Due to the beam collection feature of said reflector (20m) from a range of 60 degrees, the movement of the reflector does not have to be fast and accurate at that time; there is a sufficiently long time interval to reach the parallel position with the azimuth axis. This position is shown in FIG. 10. To keep the hyperbolic reflector (20m) in this position, different lock mechanisms (FIG. 14) can be used. After the sun's zenith angle sweeping of approximately 120 degrees, the hyperbolic reflector (20m) is rotated to the west direction again and is changed this time to a fixed position on the side support (23) in the west direction. After the sun completes the zenith angle of approximately 120 degrees, the hyperbolic reflector (20) is kept in the west direction as also shown in FIG. 11 during the time to sunset point. Following the sunset, the hyperbolic reflector (20m) are brought back to its initial position through re-rotating towards the east direction—there is a long time like all night for this operation—and positioning on the side support (23′) in the east direction. In cases where the geographical regions in which the said system (H) is used are different, e.g. in cases where these systems (H) are located below or above the sea level, or surrounded by heights; the movement angle of the sun on the earth all day may be relatively different. In other words, the sun can sweep a more or less angle than the movement route of 180 degrees as mentioned above. In these cases, the heights of the side supports (23, 23′) might also be different according to the characteristics of the geographies in which said systems (H) are used. In such cases, the apertures of the hyperbolic reflectors (20m) and the heights of the side supports (23, 23′) can be adjusted such that they divide the route that sun follows into three equal parts. For example, considering the movement route of 180 degrees and that the sun rises from a level of 0 degree and declines from a level of 180 degrees as mentioned above, the aperture of the reflectors (20m) can be adjusted such that it will collect the beams coming from a range of 60 degrees and the heights of the side supports (23, 23′) can be adjusted such that they will direct the reflectors (20m) to an axis of 30 degrees from the horizon when the reflectors (20m) are seated thereon.

In an embodiment of the subject matter of the invention of hyperbolic solar trough field system (H), a support ring (29) was installed on the bottom part of the hyperbolic reflector (20m). Above-mentioned thermal receiver tubes (21) are located on the central axis of the support ring (29). The system (H) rotates around this axis which is also the focal axis of the reflectors (20m). In the hyperbolic solar trough field system (H), the support rings (29) are supported from their bottom parts through rotary joints (22) and rotate on the rotary joints (22) by sliding. The rotary joints (22) were installed below the support rings (29) such that they allow the rings (29) to rotate around their center. In addition, the strength of the system (H) is increased by using a lightweight filling material between the support ring (29) and the hyperbolic reflector (20m).

Since the reflectors (20m) in the hyperbolic solar trough field system (H) collect the sunlight from a range of approximately 60 degrees and thus are located only in three positions in a day, the necessity for reflectors (20m) to move synchronously with each other during position change is eliminated. Thus, accurate and continuous sun tracking is not needed, and there is no need for the complex electronic control units and programs which are necessary for this tracking. This critical consideration decreases not only the design, manufacturing and maintenance expenses substantially but also simplifies the operation equally.

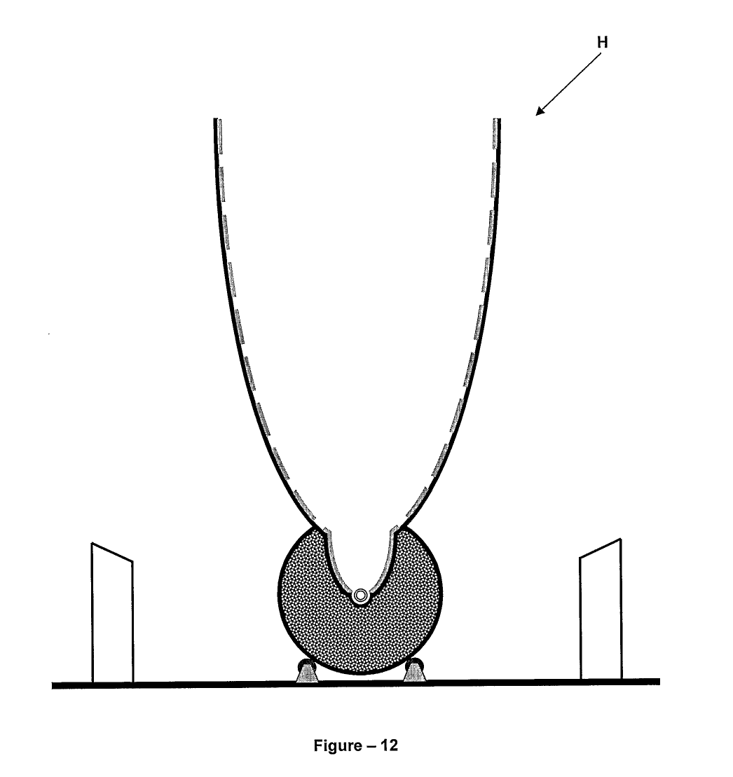

Although the sun tracking activity with continuous and accurate movement through the said system (H) decreases the production, maintenance and repair costs of the system (H), the multi-piece reflectors may also be used in order to decrease the costs arising from the single-piece hyperbolic reflector manufacturing. FIG. 12 provides a multi-piece side view of the hyperbolic reflector in the hyperbolic solar trough field system (H). By means of the invention, instead of single-piece ones, longitudinal multi-piece hyperbolic reflectors can also be used alternatively. By means of this multi-piece structure, even if some reflector parts are broken, it is easy to change them. In addition, the breaking of single-piece reflectors due to the external effects can damage the substantial part of the reflectors. By means of multi-piece structure, only the reflectors which remain under the effect are broken, and the possibility of damage to entire hyperbola decreases. In addition, maintenance and replacement expenses, which may arise when the hyperbolic reflectors are broken, decrease and even if some reflector parts are broken, the system can continue to run without suffering too much efficiency loss. In the multi-piece hyperbolic reflectors, the edge width of those which are close to the center of the hyperbola is narrow and the width of these reflector parts increases towards the sides of the hyperbola. The surfaces of the multi-piece hyperbolic reflectors which face towards the thermal receiver tubes can be produced in two different ways. The first alternative is to make these surfaces planar. The reflectors which are placed on the concave surfaces of this hyperbolic solar trough are placed on this trough such that they reflect the light coming onto their flat surfaces to the thermal receiver tube. The second alternative is that said surfaces of these multi-piece reflectors are each in the form of a hyperbola section. In other words, said multi-piece reflector is made of bringing the longitudinal sections of a single hyperbolic reflector together. When said hyperbola sectioned reflectors are positioned longitudinally and collaterally on the concave surface of a hyperbolic solar trough again, a multi-piece hyperbolic reflector system, where the focal point of each is the thermal receiver tube, is produced. In said system (H), if the flat-surface reflector parts are used which are proposed as the first alternative, each flat panel should be narrow in width and therefore the number of panels used should be too many in order to allow a better focusing. If the multi-piece reflectors made of hyperbolic sections which are proposed in the second alternative are used, it is possible to use less reflector parts since each reflector width is wider than the flat-surface ones. Since both alternatives have their own advantages, a selection can be made between these two alternatives according to the manufacturing capacity. Owing to their flat surfaces, manufacturing of the reflector parts mentioned in the first alternative is easier than the manufacturing of the hyperbolic sectioned reflector parts. Besides, although the manufacturing of the hyperbolic sectioned reflectors are more difficult, they focus the sunlight better.

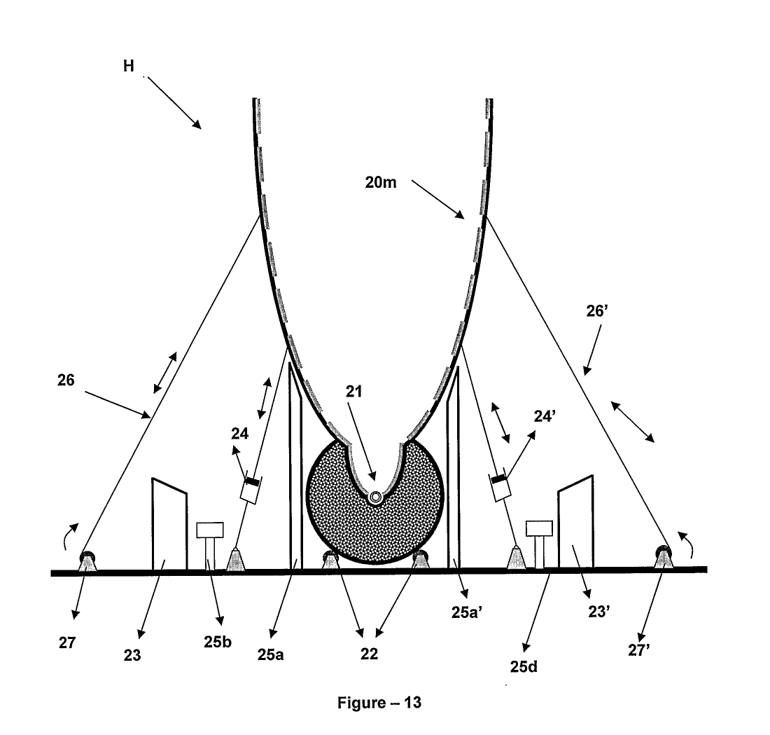

FIG. 13 provides a side view of the hyperbolic solar trough field system (H) along with the drive and support units. In order to rotate the hyperbolic reflectors (20m) around a pivot point, different drive mechanisms can be used. These mechanisms can be in the form of motor-reducer units or chain-gear or belt-pulley arrangements which are attached to these units and additionally in the form of drive arms. These said mechanisms (not shown in the figures) can be attached to the rotary joints (22) or the hyperbolic reflector (20m). By means of these mechanisms, the hyperbolic reflectors (20m) can be rotated around the focal axis. With the invention, it is preferred to position the reflectors using multiple motors with less capacity. In this way, using multiple motors instead of a single motor unit which has sufficient capacity to rotate all reflectors, it is aimed that the entire reflector system continues to run even if some of the motors fail.

Another example of the drive mechanisms may be hydraulic or pneumatic pistons (24, 24′) as shown in FIG. 13. It is possible to position the reflectors (20m) in the east-west direction with the help of the pistons (24, 24′) of which one ends are connected to the sides of the hyperbolic reflectors (20m) and other ends are connected to a fixed point. Or the reflectors (20m) can be positioned with the help of the guy wires (26, 26′) of which one ends are connected to the side of the reflectors (20m) and other ends are each connected to one pulley (27, 27′). During the use of guy wires (26, 26′) as the drive system, the length of these wires (26, 26′) can be adjusted according to the rotation of the pulleys rotated by individual drive units.

In the hyperbolic solar trough field system (H), the lock mechanisms (25a, 25a′, 25b, 25d) can also be used in order to protect the hyperbolic reflectors (20m) from the wind loads and reduce the oscillation amount when they are at a fixed position. Owing to these mechanisms which are positioned on the beginning and ending parts of the hyperbolic reflectors (20m), when the reflectors are changed to the fixed position in the east, azimuth axis and west directions, the arms of the lock mechanisms move in the north-south direction and support the reflector (20m) in its fixed positions. When the reflectors (20m) are changed to the east position, they are kept fixed between the side supports (23′) and the east locks (25d). When the reflectors (20m) are changed to the parallel position to the azimuth axis, they are kept fixed between the azimuth locks (25a, 25a′). When the reflectors (20m) are changed to the west position, they are kept fixed between the side supports (23) and the west locks (25b). FIG. 14 provides a front view of the hyperbolic reflectors (20m) along with the lock mechanisms (25a, 25a′, 25b, 25d). When the reflectors (20m) are required to be kept in a fixed position, the movable arms in the lock mechanisms move in the north-south direction and lock the reflectors (20m); when the reflectors (20m) change the position, they move again in the north-south direction and release the reflectors. In case where the multiple hyperbolic reflectors (20m) are used, the reflector connections (28) shown in FIG. 14 are used as a connection member between the reflectors (20m) in order to connect each reflector (20m) to each other and thus allow them to move together. The positions of the reflector connections (28) are at the top parts of the reflectors (20m) such that they do not strike the lock mechanisms (25a, 25a′, 25b, 25d).

Different alternatives can be applied for the thermal receiver tubes (21) which are used in hyperbolic solar trough field system (H). In the first alternative, the thermal receiver tube (21) consists of two tubes which are nested, concentric with each other and have a vacuum space therebetween. A fluid is passed through the inner tube, which is called transfer tube, with high thermal conductivity for the heat transfer. Outer glass tube allows the beams coming from the hyperbolic reflectors to reach directly the transfer tube. The temperature of the transfer tube and the fluid therein increases in this way. In order to avoid heat loss through convection from transfer tube to outside, a vacuum space is created between the glass tube and the transfer tube.

In the second alternative, unlike the previous thermal receiver tube, this tube is made of glass and the heat fins with high thermal conductivity are used therein in order to heat the fluid passing through this tube more quickly. Said heat fins may be the fins which are in the form of a plate; however they may be used in the form of pins as well. Plate-shaped fins provide manufacturing and mounting easiness compared to pin-shaped fins. Since the pin-shaped ones cast a less shadow on one another, they are more efficient than the plate-shaped ones. It is possible to use both fin structures in this system (H). In the second alternative, it is required to use a second glass tube on the outer parts of the suitable thermal receiver tubes such that a vacuum space will be between said glass tube and the inner tube. The heat fins which are suitable for the second alternative are located longitudinally inside the glass tube and integrally with this tube.

Since the thermal receiver tube (21) is somewhat surrounded by the hyperbolic reflector (20m) in the hyperbolic solar trough field system (H), it is less affected by the external environment conditions. Therefore, since the outer glass tube is not preferred in the thermal receiver tube (21) which is suitable for the above-mentioned first alternative, there is no need to perform the operations such as combining the glass tubes which are many meters long, creating a vacuum space, providing tightness; and there arises an opportunity to save money on the issues such as material, workmanship, maintenance, repair owing to the absence of these glass tubes which are the most fragile components of the system even if they are in a fixed position.

The above preferred hyperbolic solar trough field systems (H) are not intended to limit the protection scope of the invention. According to the information described with the invention, the modifications to be performed on this preferred hyperbolic solar trough field systems (H) should be evaluated within the protection scope of the invention.

1-65. (canceled)

66. A hyperbolic solar trough field system (B), comprising hyperbolic reflectors (20) in which the beams that come from the sun parallel and the angles of incident thereof change throughout the day are concentrated on the focal axis in the bottom part thereof and thermal receiver tubes (21) which extend throughout said focal axis and are at a fixed position, is characterized in that
the bottom part of said hyperbolic reflector (20) is circular sectioned such that it surrounds the thermal receiver tubes (21) somewhat, and on the continuation; its arms extending towards two sides are in the form of hyperbola;
it comprises at least one rotary joint (22) which is used to allow the reflectors (20) to rotate around the central axis of the thermal receiver tubes (21) and are connected to the bottom part of the reflectors (20) and the ground, and the side supports (23, 23′) which are at a ground-fixed position on the both sides of the reflectors (20);
the apertures of the hyperbolic reflectors (20) and the heights of the side supports (23, 23′) are such that they collect the beams from the one third part of the route that the sun follows and the reflectors (20) are directed towards the sun in three different positions such that they face to the east direction, the apex point of the elliptic route that the sun follows and the west direction; and
the hyperbolic reflector (20) has a structure which is able to focus the beams, coming from a range which constitutes the one third part of the route that the sun follows, on the thermal receiver tubes which are located at the bottom part thereof.

67. A hyperbolic solar trough field system (B) according to the claim 66, wherein drive mechanisms which are associated with the joints (22) and/or reflectors (20) are used, in order to rotate and direct the reflectors (20) towards the sun.

68. A hyperbolic solar trough field system (B) according to the claim 66, wherein the hyperbolic reflector (20) is at a fixed position on the side support (23′) in the east direction during the time to reach the one third part of the total zenith angle that it will sweep after sunrise; while the sun continues its travel towards the apex point of the elliptic route that it follows after completing said one third part approximately, the hyperbolic reflector (20) is rotated and brought into a position where it is parallel to the azimuth axis;
after the sun sweeps the second one third part of the total zenith angle that it will sweep approximately, the hyperbolic reflector (20) is rotated to the west direction again and is changed this time to a fixed position on the side support (23) in the west direction; following the sunset, the hyperbolic reflector (20) are brought back to its initial position through re-rotating towards the east direction and positioning on the side support (23′) in the east direction.

69. A hyperbolic solar trough field system (B) according to the claim 66, wherein single-piece hyperbolic reflectors (20) are used.

70. A hyperbolic solar trough field system (B) according to the claim 66, wherein longitudinal multi-piece reflectors are used in order to reduce the cost arising from the manufacturing of single-piece hyperbolic reflectors (20) and change the broken ones easily if some of the reflectors are broken.

71. A hyperbolic solar trough field system (B) according to the claim 70, wherein the surfaces of the multi-piece hyperbolic reflectors which face towards the thermal receiver tubes are flat, the reflector parts which are placed on the concave surfaces of a hyperbolic solar trough are placed on this trough such that they reflect the light coming onto their flat surfaces to the thermal receiver tube and the edge width of the multi-piece hyperbolic reflectors parts which are close to the center of the hyperbola is narrow and the width of these reflector parts increases towards the sides of the hyperbola.

72. A hyperbolic solar trough field system (B) according to the claim 71, wherein the surfaces of multi-piece hyperbolic reflectors facing towards the thermal receiver tubes are each in the form of a hyperbola section and when said hyperbola sectioned reflectors are positioned longitudinally and collaterally on the concave surface of a hyperbolic solar trough again, they produce a multi-piece hyperbolic reflector system, where the focal point of each is the thermal receiver tube.

73. A hyperbolic solar trough field system (B) according to the claim 66, wherein the drive mechanisms, which are used to rotate the hyperbolic reflectors (20) around their focal axis, can be motor-reducer units, chain-gear arrangements connected to the motor-reducer units, belt-pulley arrangements connected to the motor-reducer units or drive arms connected to the motor-reducer units.

74. A hyperbolic solar trough field system (B) according to the claim 73, wherein the drive mechanisms are connected to the rotary joints (22) or the hyperbolic reflectors (20).

75. A hyperbolic solar trough field system (B) according to the claim 66, wherein the multiple motor units with lesser capacity, instead of a single motor unit which has sufficient capacity to rotate all reflectors (20), are used.

76. A hyperbolic solar trough field system (B) according to the claim 66, wherein the drive mechanisms are hydraulic or pneumatic pistons (24, 24′).

77. A hyperbolic solar trough field system (B) according to the claim 76, wherein one ends of the pistons (24, 24′) are connected to the sides of the hyperbolic reflectors (20) and other ends thereof are connected to a fixed point in order to allow said reflectors (20) to move in the east-west direction.

78. A hyperbolic solar trough field system (B) according to the claim 66, wherein the guy wires (26, 26′) of which one ends are connected to the side of the reflectors (20) and other ends are each connected to one pulley (27, 27′) are used as a drive mechanism which is used to position the reflectors (20) and the length of these wires (26, 26′) can be adjusted according to the rotation of the pulleys (27, 27′) rotated by individual drive units.

79. A hyperbolic solar trough field system (B) according to the claim 66, wherein it comprises lock mechanisms (25a, 25a′, 25b, 25d) which are positioned on the beginning and ending parts of the hyperbolic reflectors (20) in order to protect them from the wind loads and reduce the oscillation amount when the hyperbolic reflectors (20) are changed to the fixed position in the east, azimuth axis and west directions, and support the reflector (20) in its fixed positions by the arms thereof moving in the north-south direction or are opened by the arms thereof moving in the north-south direction again when the reflectors (20) have to move.

80. A hyperbolic solar trough field system (B) according to the claim 79, wherein the reflectors (20) remain fixed between the side supports (23′) and the east locks (25d) when they are changed to the east direction, between the azimuth locks (25a, 25a′) when they are changed to the position which is parallel to the azimuth axis and between the side supports (23) and the west locks (25b) when they are changed to the west direction.

81. A hyperbolic solar trough field system (B) according to the claim 66, wherein it comprises the reflector connections (28) on the top parts of the reflectors (20) such that they do not strike the lock mechanisms (25a, 25a′, 25b, 25d), as a connection member between the reflectors (20) in order to connect each reflector (20) to each other and allow them to move together if the multiple hyperbolic reflectors (20) are used.

82. A hyperbolic solar trough field system (B) according to the claim 66, wherein the thermal receiver tube (21) is comprised of two tubes which are nested, concentric with each other and have a vacuum space therebetween;
the inner tube is in the form of a tube with high thermal conductivity through which a fluid is passed for the heat transfer; the outer tube is in the form of a glass tube which allows the beams coming from the hyperbolic reflector to reach directly the inner tube.

83. A hyperbolic solar trough field system (B) according to the claim 66, wherein the thermal receiver tube is made of glass only and has heat fins with high thermal conductivity therein in order to heat the fluid passing therethrough more quickly.

84. A hyperbolic solar trough field system (B) according to the claim 83, wherein the heat fins are in the form of a plate or in the form of pins.

85. A hyperbolic solar trough field system (B) according to the claim 83, wherein there is a second glass tube on the outer parts of the thermal receiver tubes such that a vacuum space will be between the inner and the outer tubes.

86. A hyperbolic solar trough field system (B) according to the claim 66, wherein only a tube with high thermal conductivity through which a fluid is passed for the heat transfer is used in thermal receiver tubes without using a glass tube.

87. A hyperbolic solar trough field system (H), comprising hyperbolic reflectors (20m) in which the beams that come from the sun parallel and the angles of incident thereof change throughout the day are concentrated on the focal axis in the bottom part thereof and thermal receiver tubes (21) which extend throughout said focal axis and are at a fixed position, is characterized in that
the bottom part of said hyperbolic reflector (20m) is circular sectioned such that it surrounds the thermal receiver tubes (21) somewhat, and on the continuation; its arms extending towards two sides are in the form of hyperbola (20m′); there is a bigger hyperbolic structure (20m″), also in the form of a hyperbola, which starts from the point where said hyperbola form (20m′) finishes and extends towards both sides;
in order to ensure the more efficient operation of the hyperbolic solar trough field system (H) by concentrating the beams coming from the sun more on the tube (21) and to reduce the problem concerning the concentration of the sunlight on the thermal receiver tubes with the enlarged hyperbolic reflectors (20m); the hyperbolic reflector (20m) comprising dual-stage hyperbolas (20m′, 20m″) is such that firstly the beams coming from the sun parallel and at varying degrees reflect from the inner surface of the big hyperbolic form (20m″) and reach the inner surface of the small hyperbola form by passing through the aperture of the small hyperbolic form (20m′) and then are concentrated on the thermal receiver tubes (21) by reflecting therefrom;
it comprises at least one rotary joint (22) which is used to allow the reflectors (20m) to rotate around the central axis of the thermal receiver tubes (21) and are connected to the bottom part of the reflectors (20m) and the ground; and
the hyperbolic reflector (20m) has a structure which is able to focus the beams coming from a range which constitutes the one third part of the route that the sun follows on the thermal receiver tubes which are located at the bottom part thereof.

88. A hyperbolic solar trough field system (H) according to the claim 87, wherein in order to rotate and direct the reflectors (20m) towards the sun, drive mechanisms which are associated with the joints (22) and/or reflectors (20m) are used.

89. A hyperbolic solar trough field system (H) according to the claim 87, wherein the hyperbolic reflector (20m) is at a fixed position on the side support (23′) in the east direction during the time to reach the one third part of the total zenith angle that it will sweep after sunrise; while the sun continues its travel towards the apex point of the elliptic route that it follows after completing said one third part approximately, the hyperbolic reflector (20m) is rotated and brought into a position where it is parallel to the azimuth axis; after the sun sweeps the second one third part of the total zenith angle that it will sweep approximately, the hyperbolic reflector (20m) is rotated to the west direction again and is changed this time to a fixed position on the side support (23) in the west direction; following the sunset, the hyperbolic reflector (20m) are brought back to its initial position through re-rotating towards the east direction and positioning on the side support (23′) in the east direction.

90. A hyperbolic solar trough field system (H) according to the claim 87, wherein single-piece hyperbolic reflectors (20m) are used.

91. A hyperbolic solar trough field system (H) according to the claim 87, wherein longitudinal multi-piece reflectors are used in order to reduce the cost arising from the manufacturing of single-piece hyperbolic reflectors (20m) and change the broken ones easily if some of the reflectors are broken.

92. A hyperbolic solar trough field system (H) according to the claim 91, wherein the surfaces of the multi-piece hyperbolic reflectors which face towards the thermal receiver tubes (21) are flat, the reflector parts which are placed on the concave surfaces of a hyperbolic solar trough are placed on this trough such that they reflect the light coming onto their flat surfaces to the thermal receiver tube (21) and the edge width of the multi-piece hyperbolic reflector parts which are close to the center of the hyperbola is narrow and the width of these reflector parts increases towards the sides of the hyperbola.

93. A hyperbolic solar trough field system (H) according to the claim 91, wherein the surfaces of multi-piece hyperbolic reflectors facing towards the thermal receiver tubes are each in the form of a hyperbola section and when said hyperbola sectioned reflectors are positioned longitudinally and collaterally on the concave surface of a hyperbolic solar trough again, they produce a multi-piece hyperbolic reflector system, where the focal point of each is the thermal receiver tube.

94. A hyperbolic solar trough field system (H) according to the claim 87, wherein the drive mechanisms, which are used to rotate the hyperbolic reflectors (20m) around their focal axis, can be motor-reducer units, chain-gear arrangements connected to the motor-reducer units, belt-pulley arrangements connected to the motor-reducer units or drive arms connected to the motor-reducer units.

95. A hyperbolic solar trough field system (H) according to the claim 94, wherein the drive mechanisms are connected to the rotary joints (22) or the hyperbolic reflectors (20m).

96. A hyperbolic solar trough field system (H) according to the claim 87, wherein the multiple motor units with lesser capacity, instead of a single motor unit which has sufficient capacity to rotate all reflectors (20m), are used.

97. A hyperbolic solar trough field system (H) according to the claim 87, wherein the drive mechanisms are hydraulic or pneumatic pistons (24, 24′).

98. A hyperbolic solar trough field system (H) according to the claim 97, wherein one ends of the pistons (24, 24′) are connected to the sides of the hyperbolic reflectors (20m) and other ends thereof are connected to a fixed point in order to allow said reflectors (20m) to move in the east-west direction.

99. A hyperbolic solar trough field system (H) according to the claim 87, wherein the guy wires (26, 26′) of which one ends are connected to the side of the reflectors (20m) and other ends are each connected to one pulley (27, 27′) are used as a drive mechanism which is used to position the reflectors (20m) and the length of these wires (26, 26′) can be adjusted according to the rotation of the pulleys rotated by individual drive units.

100. A hyperbolic solar trough field system (H) according to the claim 87, wherein it comprises lock mechanisms (25a, 25a′, 25b, 25d) which are positioned on the beginning and ending parts of the hyperbolic reflectors (20m) in order to protect them from the wind loads and reduce the oscillation amount when the hyperbolic reflectors (20m) are changed to the fixed position in the east, azimuth axis and west directions, and support the reflector (20m) in its fixed positions by the arms thereof moving in the north-south direction or are opened by the arms thereof moving in the north-south direction again when the reflectors (20m) have to move.

101. A hyperbolic solar trough field system (H) according to the claim 100, wherein the reflectors (20m) remain fixed between the side supports (23′) and the east locks (25d) when they are changed to the east direction, between the azimuth locks (25a, 25a′) when they are changed to the position which is parallel to the azimuth axis and between the side supports (23) and the west locks (25b) when they are changed to the west direction.

102. A hyperbolic solar trough field system (H) according to the claim 87, wherein it comprises the reflector connections (28) on the top parts of the reflectors (20m) such that they do not strike the lock mechanisms (25a, 25a′, 25b, 25d), as a connection member between the reflectors (20m) in order to connect each reflector (20m) to each other and allow them to move together if the multiple hyperbolic reflectors (20m) are used.

103. A hyperbolic solar trough field system (H) according to the claim 87, wherein the thermal receiver tube (21) is comprised of two tubes which are nested, concentric with each other and have a vacuum space therebetween;
the inner tube is in the form of a tube with high thermal conductivity through which a fluid is passed for the heat transfer; the outer tube is in the form of a glass tube which allows the beams coming from the hyperbolic reflector to reach directly the inner tube.

104. A hyperbolic solar trough field system (H) according to the claim 87, wherein the thermal receiver tube (21) is made of glass only and has heat fins with high thermal conductivity therein in order to heat the fluid passing therethrough more quickly.

105. A hyperbolic solar trough field system (H) according to the claim 104, wherein the heat fins are in the form of a plate or in the form of pins.

106. A hyperbolic solar trough field system (H) according to the claim 104, wherein there is a second glass tube on the outer parts of the thermal receiver tubes (21) such that a vacuum space will be between the inner and the outer tubes.

107. A hyperbolic solar trough field system (H) according to the claim 87, wherein only a tube with high thermal conductivity through which a fluid is passed for the heat transfer is used in thermal receiver tubes (21) without using a glass tube.

108. A hyperbolic solar trough field system (H) according to the claim 87, wherein it comprises the side supports (23, 23′) which are at a ground-fixed position on the both sides of the reflectors (20m).

109. A hyperbolic solar trough field system (H) according to the claim 87, wherein the apertures of the hyperbolic reflectors (20m) and the heights of the side supports (23, 23′) are such that they collect the beams from the one third part of the route that the sun follows and the reflectors (20m) are directed towards the sun in three different positions such that they face to the east direction, the apex point of the elliptic route that the sun follows and the west direction.

110. A hyperbolic solar trough field system (H) according to the claim 87, wherein in order to re-concentrate the light focused by the big hyperbola form (20m″) so as to be collected in bottom part of the small hyperbola form (20m′), the aperture of the small hyperbola form (20m′) is equal to the focus area of the big hyperbola form (20m″).

111. A hyperbolic solar trough field system (H) according to the claim 87, wherein it comprises the support rings (29) which are installed on the bottom part of the hyperbolic reflector (20m), the rotary joints (22) which are installed below the support rings (29) such that they allow the rings (29) to rotate around their center and the thermal receiver tubes (21) which are located on the central axis of the support rings (29) which is also the focal axis of the reflectors (20m).

112. A hyperbolic solar trough field system (H) according to the claim 111, wherein a lightweight filling material is additionally used between the support ring (29) and the hyperbolic reflector (20m).
